(19) United States
(12) Patent Application Publication
(10) Pub. No.: US 2018/0368498 A1
(43) Pub. Date: Dec. 27, 2018

(54) Gardening Glove

(71) Applicant: Vassilios Coutsis, Brantford (CA)

(72) Inventor: Vassilios Coutsis, Brantford (CA)

(21) Appl. No.: 15/629,417

(22) Filed: Jun. 21, 2017

(51) Int. Cl. A41D 19/015; A41D 19/00; A01D 46/247

(52) U.S. Cl. CPC A41D 19/01594; A01D 46/247; A41D 19/0048

(57) ABSTRACT

A gardening glove that is a comfortable slip on glove, having a sharp stainless steel edge on the thumb for an effective and easy cutting of stems during the gardening process.

### PRIORITY

This applications claims priority from the disclosure of U.S. Provisional Patent Application No. 62/352,332, filed on 21 Jun. 2016, which is incorporated by reference herein.

### BACKGROUND OF THE INVENTION

### 1. Field of the Invention

The present invention relates generally to the field of gloves and more specifically relates to a Gardening Glove.

### 2. Description of the Related Art

A glove is a garment covering the whole hand. Gloves have separate sheaths or openings for each finger and the thumb. Gloves protect and comfort hands against cold or heat, damage by friction, abrasion or chemicals, and disease; or in turn to provide a guard for what a bare hand should not touch.

Gloves appear to be of great antiquity. According to some translations of Homer's The Odyssey, Laertes is described as wearing gloves while walking in his garden so as to avoid the brambles. Herodotus, in The History of Herodotus (440 BC), tells how Leotychides was incriminated by a glove (gauntlet) full of silver that he received as a bribe. There are occasional references to the use of gloves among the Romans as well. Pliny the Younger (c. 100), his uncle's shorthand writer wore gloves in winter so as not to impede the elder Pliny's work.

Early Formula One race cars used steering wheels taken directly from road cars. They were normally made from wood, necessitating the use of driving gloves.

When short sleeves came into fashion in the 1700s, women began to wear long gloves, reaching half-way up the forearm. In modern times, gloves are commonly worn while gardening to prevent dirt from becoming packed beneath the finger nails and to protect the hands from thorns or sharp objects. Grape growers wear gloves during most of the care taking process as well. One inconvenience is that the gloves must be removed in order to cut the vines. A need exists for gloves used for gardening that can protect the hand while at the same time pinch to cut the stems and remove the fruit easily.

Various attempts have been made to solve the problems which may be found in the related art but have thus far been unsuccessful. A need exists for a reliable Gardening Glove to avoid the above-mentioned problems. There still is room for improvement in the art.

### BRIEF SUMMARY OF THE INVENTION

In view of the foregoing disadvantages inherent in the known art, the present invention provides a novel Gardening Glove. The general purpose of the present invention, which will be described subsequently in greater detail, is to provide a comfortable slip on garden glove, comprising a sharp stainless steel edge on the thumb for an effective and easy process of cutting of stems during the gardening process. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Smart Harvest Gardening Glove, constructed and operative according to the teachings of the present invention.

FIG. 1 shows a top view illustrating a gardening glove according to an embodiment of the present invention;

FIG. 2 shows the gardening glove being used;

FIG. 3 shows a bottom view of the gardening glove; and

FIG. 4 shows a top view of the gardening glove.

The various embodiments of the present invention will hereinafter be described in conjunction with the appended drawings.

### DETAILED DESCRIPTION

As discussed above, embodiments of the present invention relate to a glove device and more particularly to a Gardening Glove 1.

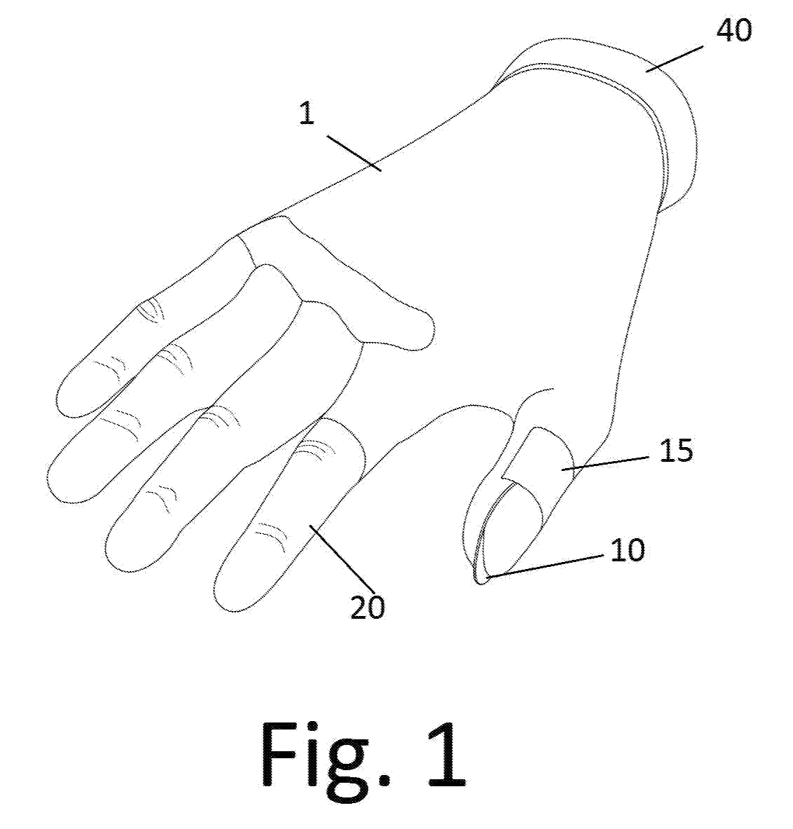

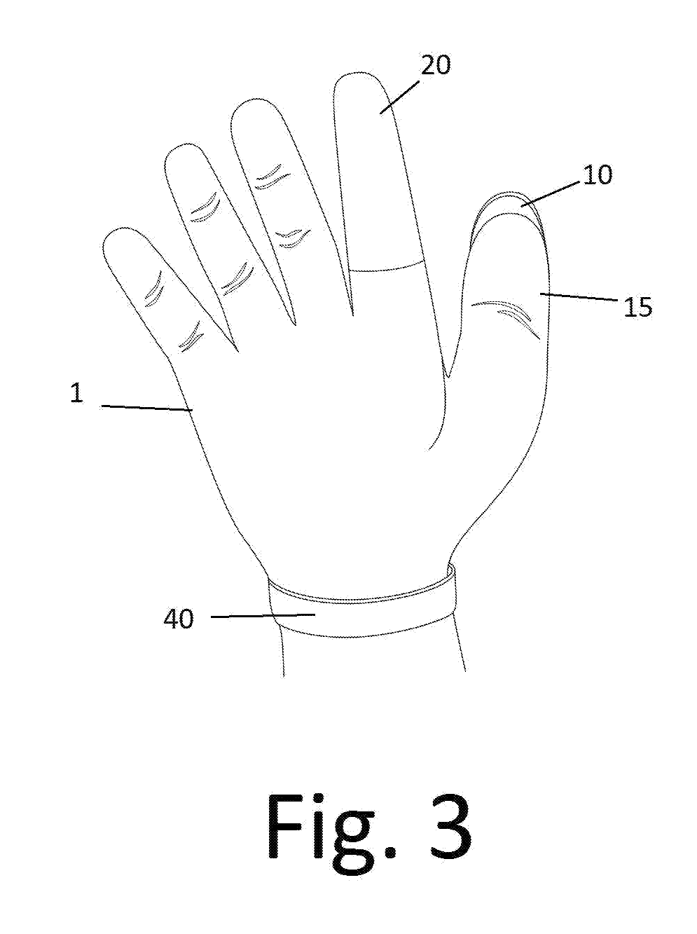

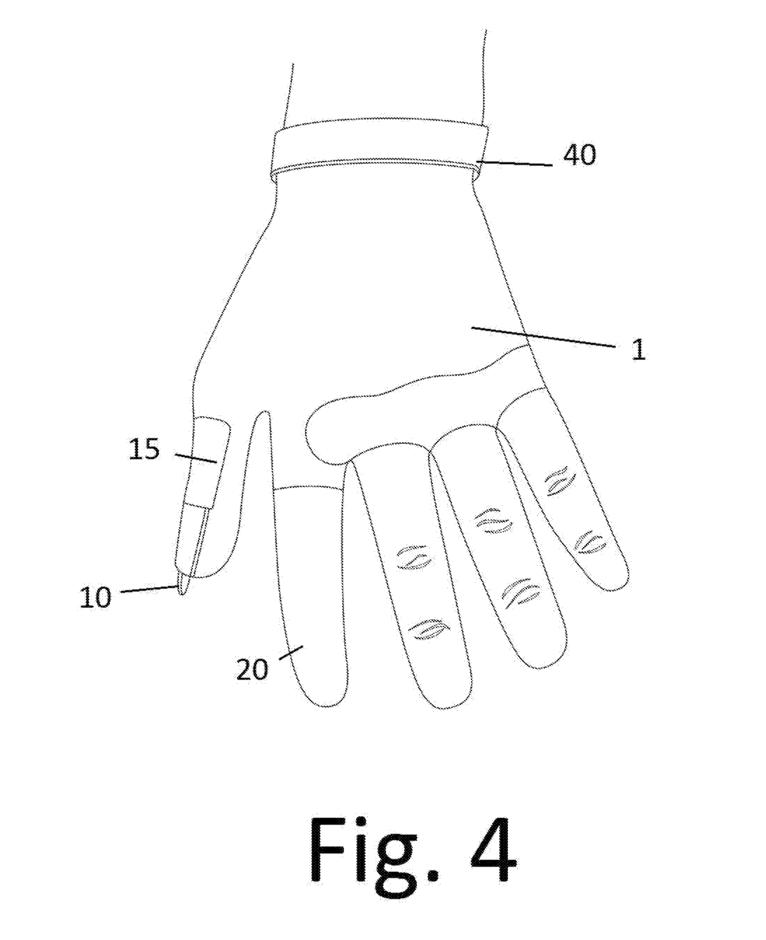

Referring now to the FIGS. 1 through 4 which shows the Gardening Glove 1 according to an embodiment of the present invention. The garden glove 1 is a comfortable slip on glove, having a sharp stainless steel edge 10 on the thumb for an effective and simplified cutting process. The reinforced, leather index finger 20 will provide protection during use while gardening.

The reinforced, leather index finger 20 will provide protection during use while gardening. In the preferred embodiment, it is reinforced with leather but other materials can be used. In the preferred embodiment, the edge 10 is made of sharp stainless steel but other material can be used.

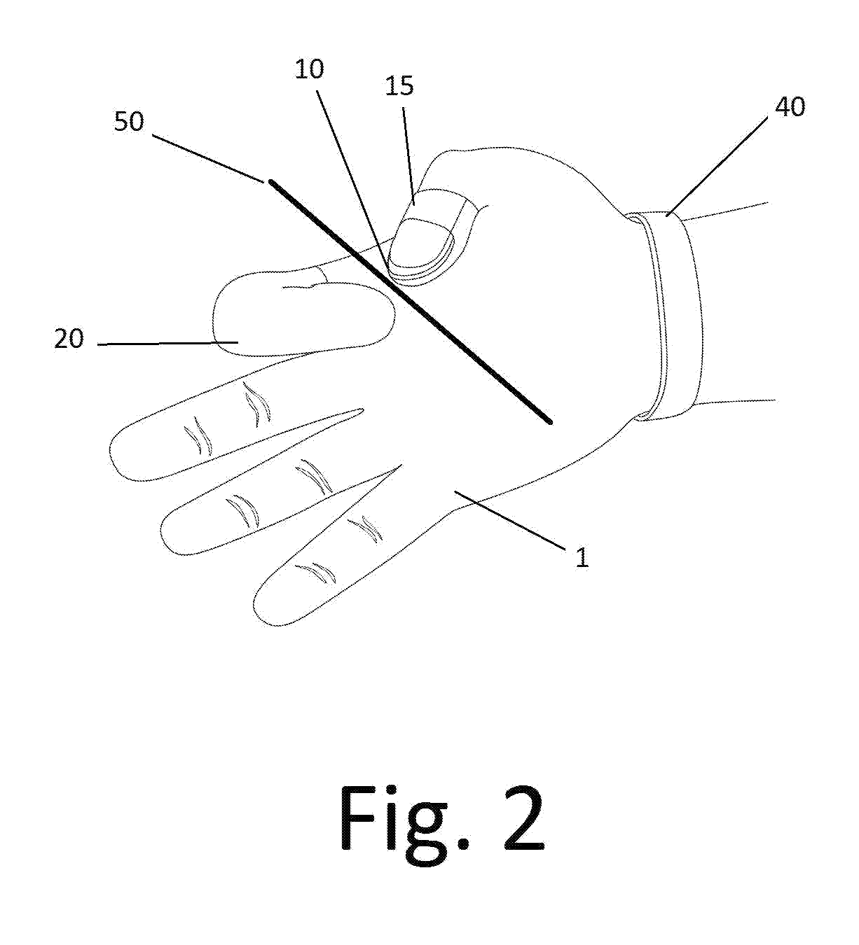

Referring now to the drawings FIG. 2 shows the Gardening Glove 1 in use. The blade 10 is positioned at the tip of the thumb 15 to ensure that full range of movement in the joint is maintained. A user simply holds the stem 50 or a batch of grapes in the palm of their hand and carefully pinches the thumb blade 10 against the reinforced index finger 20 to cut the stem 50. The reinforced index finger 20 is reinforced to so that the thumb blade 10 can cut the stems 50 without cutting through to the user's finger or hand.

The gardening glove 1 has a firm wrist grip 40 which is an elastic band or material at the wrist that keeps the glove 1 in place.

The gardening glove 1 is made of a material like rubber or leather that offers hand protection. This keeps a user's hand safe from harm while gardening and cutting.

The gardening glove 1 can be left handed or right handed.

### Advantages

Harvesting can be a slow and grueling process but it doesn't have to. With the Metal Blade no tools necessary, all a user needs is their hand. The index finger grip enhances control with crops.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is new and desired to be protected by Letters Patent is set forth in the appended claim:

1. A gardening device comprising;
A glove with a sharp edge on one of the tips and a reinforced finger.

2. A gardening device according to claim 1 further comprising;
Where the edge is on the tip of the thumb.

2. A gardening device according to claim 1 further comprising;
Where the reinforced finger is the index finger.

4. A gardening device according to claim 1 further comprising;
Having a wrist grip that goes around a user's wrist.

5. A gardening device according to claim 1 further comprising;
Where the edge is stainless steel.

6. A gardening device according to claim 1 further comprising;
Where the reinforced finger is made of leather.

7. A gardening device comprising;
A glove with a sharp edge on one of the tips and a reinforced finger, where the edge is on the tip of the thumb and where the reinforced finger is the index finger.

8. A gardening device according to claim 7 further comprising;
Having a wrist grip that goes around a user's wrist.

9. A gardening device according to claim 7 further comprising;
Where the edge is stainless steel.

10. A gardening device according to claim 7 further comprising;
Where the reinforced finger is made of leather.

11. A process to cut while gardening comprising;
Having a glove with a sharp edge on one of the tips and a reinforced finger, where the edge is on the tip of the thumb and where the reinforced finger is the index finger,
Holding the item to cut in the palm of the glove, and
Pinch the item between the edge and the reinforced finger to cut.

12. A process according to claim 11 further comprising;
Having a wrist grip that goes around a user's wrist.

13. A process according to claim 11 further comprising;
Where the edge is stainless steel.

14. A process according to claim 11 further comprising;
Where the reinforced finger is made of leather.
